(19) United States
(12) Patent Application Publication
(10) Pub. No.: US 2004/0212820 A1
(43) Pub. Date: Oct. 28, 2004

(54) Electronic apparatus with communication function and method of transmitting data by using the apparatus

(75) Inventor: Kaori Ogura, Mishima-shi (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/388,620

(22) Filed: Mar. 17, 2003

(51) Int. Cl. G06F 15/00; G03G 15/00

(52) U.S. Cl. 358/1.14; 399/18

(57) ABSTRACT

A CPU in a CRU-type digital multi-functional peripheral refers to a CRU alert table and reads out message information relating to a consumable component, when replacement of the consumable component occurs, and transmits a message indicative of the consumption of the consumable component and a need for replacement to a personal computer possessed by a user.

### BACKGROUND OF THE INVENTION

The present invention relates to an electronic apparatus, such as an image forming apparatus, that transmits message information relating, e.g. replacement of parts or consumable components of the electronic apparatus, to a serviceman or a user, and an information transmission method for the electronic apparatus.

Recently, an electronic apparatus such as a digital MFP (Multi-Functional Peripheral) having a communication function for sending a message relating to, e.g. replacement of consumable components, to the outside via a communication line.

In this kind of electronic apparatus, a replacement type of each part and consumable component is determined for each electronic apparatus, and a message to be displayed on an operation panel or to be sent using the communication function is set in the body of the electronic apparatus on a case-by-case basis.

This kind of electronic apparatus requires installation of an application for displaying messages in the individual electronic apparatus. Thus, the number of development steps is large, and the cost is high.

### BRIEF SUMMARY OF THE INVENTION

The object of the present invention is to provide an electronic apparatus capable of reducing the number of development steps for message information relating to, e.g. replacement of parts and consumable components of the electronic apparatus, and also reducing the cost, and an information transmission method for the electronic apparatus.

In order to achieve the object, the invention may provide an electronic apparatus with a communication function, comprising: a first memory section that pre-stores first replacement message information relating to a part or a consumable component in the electronic apparatus at a time when replacement of the part or the consumable component occurs; a second memory section that pre-stores second replacement message information relating to a part or a consumable component in the electronic apparatus at a time when replacement of the part or the consumable component occurs; and a control section that effects a control to read out the first or second replacement message information stored in the first memory section or the second memory section in accordance with Replace Unit Type information of the electronic apparatus, when replacement of the part or consumable component in the electronic apparatus occurs, and to transmit the read-out replacement message information to a predetermined transmission destination using the communication function.

The invention may also provide an information transmission method for an electronic apparatus with a communication function, comprising: pre-storing replacement message information at a time when a part or a consumable component in the electronic apparatus is replaced by a serviceman; pre-storing replacement message information at a time when a part or a consumable component in the electronic apparatus is replaced by a user; determining, when replacement of the part or the consumable component in the electronic apparatus occurs, whether the replacement of the part or the consumable component is a type for replacement by the serviceman or a type for replacement by the user; reading out the replacement message information associated with the replacement by the serviceman in a case of the type in which the replacement of the part or the consumable component in the electronic apparatus is the type for replacement by the serviceman, and transmitting the read-out replacement message information to a serviceman-side personal computer; and reading out the replacement message information associated with the replacement by the user in a case of the type in which the replacement of the part or the consumable component in the electronic apparatus is the type for replacement by the user, and transmitting the read-out replacement message information to a user-side personal computer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows a digital MFP according to an electronic apparatus of the present invention and a system configuration thereof;

FIG. 2 is a block diagram showing a schematic structure of a control system of the digital MFP;

FIG. 3 is a flow chart illustrating a message notice operation in the digital MFP; and

FIG. 4 is a flow chart illustrating a message notice operation in the digital MFP.

### DETAILED DESCRIPTION OF THE INVENTION

An embodiment of the present invention will now be described with reference to the accompanying drawings.

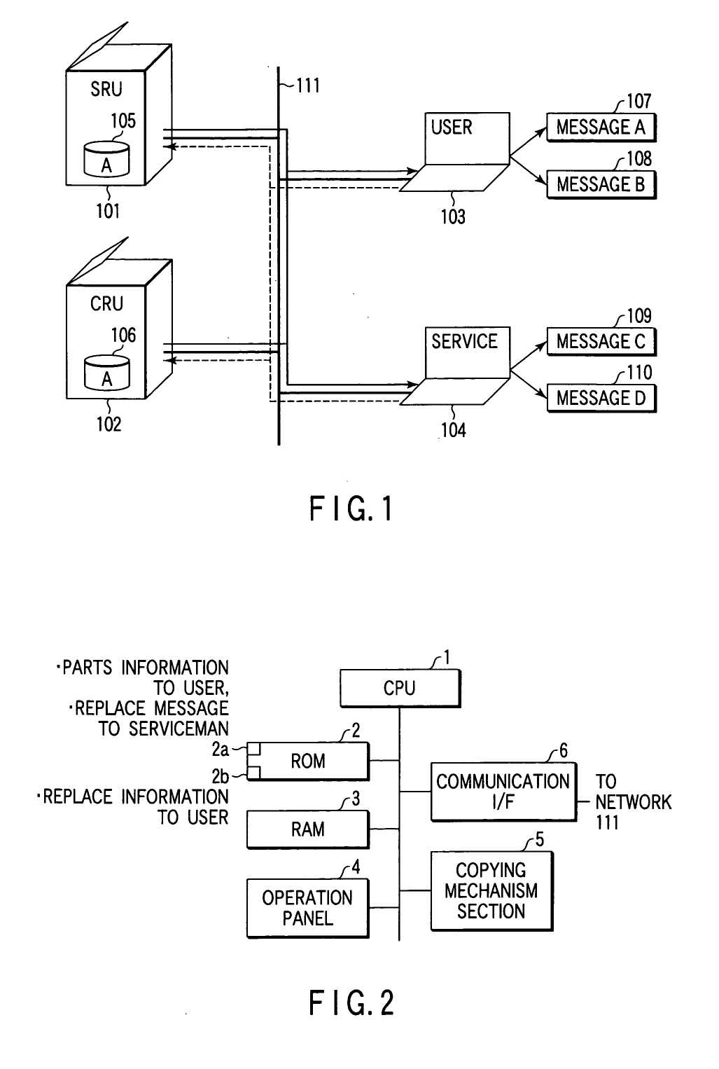

FIG. 1 shows a digital multi-functional peripheral (MFP) according to an electronic apparatus of the present invention and a system configuration thereof.

A digital MFP 101 is an SRU (Serviceman Replace Unit) type, and it is connected to a network 111 serving as a communication line.

A digital MFP 102 is a CRU (Customer Replace Unit) type, and it is connected to the network 111 serving as a communication line.

The SRU (Serviceman Replace Unit) type is an apparatus having parts and consumable components that are basically replaced by a serviceman.

The CRU (Customer Replace Unit) type is an apparatus having parts and consumable components that are replaced by a user. In other words, the CPU type is an apparatus whose parts and consumable components can be replaced by the user. In the case of this apparatus, as will be described later, a replacement message relating to parts and consumable components is sent to the user, without a call to the serviceman.

A personal computer (hereinafter referred to as “user PC”) 103 possessed by the user is also connected to the network 111, and the user PC 103 receives messages (A, B) 107 and 108 from the digital MFPs 101 and 102.

A personal computer (hereinafter referred to as “service-side PC”) 104 possessed by the service side is also connected to the network 111, and the service-side PC 104 receives messages (C, D) 109 and 110 from the digital MFPs 101 and 102.

FIG. 2 shows a schematic structure of a control system of the digital MFP 101, 102. The digital MFP 101 comprises a CPU 1 for controlling the entirety; a ROM 2 storing an SRU alert table 2a, a CRU alert table 2b and control data; a RAM 3 for temporarily storing input copy condition data, etc.; an operation panel 4 having an LCD section (not shown) and effecting an input operation; a copying mechanism section 5 functioning as image forming means; and a communication interface (communication I/F) 6 connected to the network 111.

The digital MFP 102 has the same structure, so a description thereof is omitted.

The ROM 2 pre-stores the SRU alert table 2a and CRU alert table 2b, as mentioned above.

The SRU alert table 2a stores, like the prior art, parts/consumable components information to be displayed to the user, and parts/consumable components replacement message information to be presented to the service man or a network manager.

The CRU alert table 2b stores parts/consumable components replacement message information to be presented to the user.

The aforementioned parts/consumable components in the digital MFP 101, 102 include, for instance, a toner cartridge, a photosensitive drum and a fixing device.

In accordance with the type of a digital MFP, type information is input in advance, thereby to determine whether the SRU alert table 2a or the CRU alert table 2b is to be used. The type information is input in advance through the operation panel 4 of the apparatus. Alternatively, the type information may be input from the user PC 103 or from the service-side PC 104. In short, it should suffice if one of the tables pre-stored in the ROM 2 is selected in accordance with the type of the digital MFP (electronic apparatus).

Accordingly, the SRU alert table 2a is selected in the SRU-type digital MFP 101, and the CRU alert table 2b is selected in the CRU-type digital MFP 102.

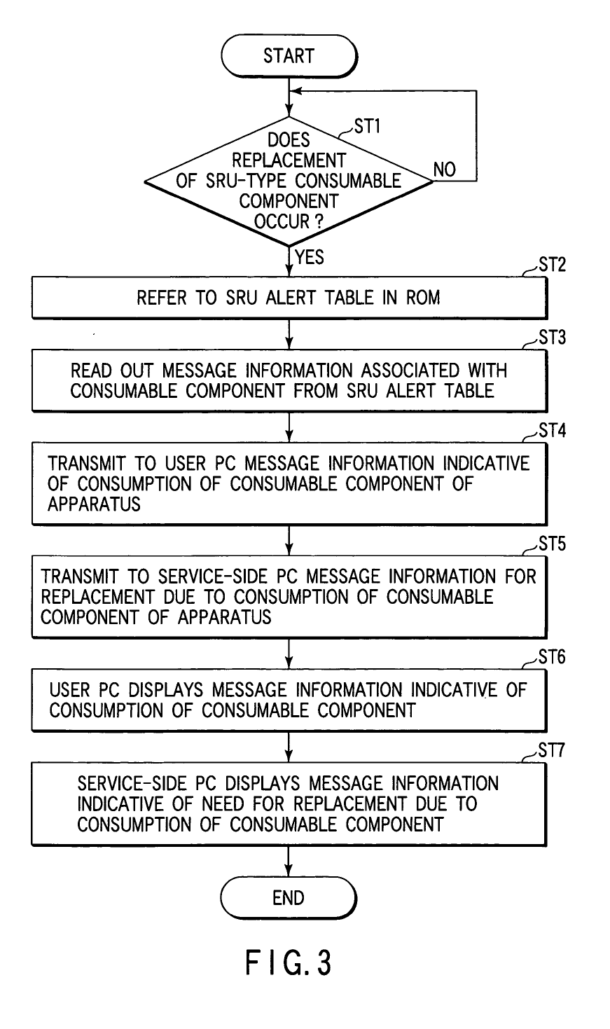

A message notice operation in the digital MFP 101 with the above-described structure will now be described with reference to a flow chart of FIG. 3.

When replacement of an SRU-type consumable component 105 in the digital MFP 101 occurs (ST1), the CPU 1 refers to the SRU alert table 2a in the ROM 2 (ST2).

The CPU 1 reads out message information corresponding to the consumable component 105 from the SRU alert table 2a (ST3), and sends to the user PC 103 via the communication I/F 6 and network 111 message information 107 to the effect that the consumable component 105 of the apparatus has been consumed (ST4).

Further, the CPU 1 sends to the service-side PC 104 via the communication I/F 6 and network 111 message information 109 about a request for replacement due to consumption of the consumable component 105 in the apparatus (ST5).

The user PC 103 displays the message information 107 indicative of the consumption of the consumable component 105 in the digital MFP 101, which has been received via the network 111 (ST6).

On the other hand, the service-side PC 104 displays the message information 109 indicative of the need for replacement due to the consumption of the consumable component 105 in the digital MFP 101, which has been received via the network 111 (ST7).

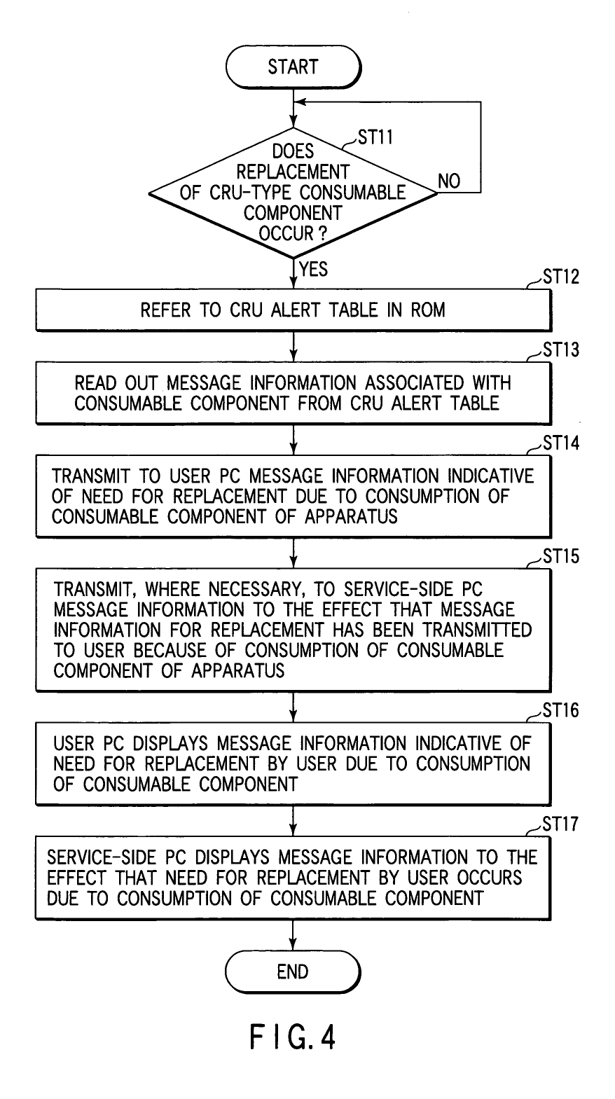

A message notice operation in the digital MFP 102 will now be described with reference to a flow chart of FIG. 4.

When replacement of a CRU-type consumable component 106 in the digital MFP 102 occurs (ST11), the CPU 1 refers to the CRU alert table 2b in the ROM 2 (ST12).

The CPU 1 reads out message information corresponding to the consumable component 106 from the CRU alert table 2b (ST13), and sends to the user PC 103 via the communication I/F 6 and network 111 a message 108 indicative of the need for replacement due to the consumption of the consumable component 106 of the apparatus (ST14).

Further, where necessary, the CPU 1 sends to the service-side PC 104 via the communication I/F 6 and network 111 a message 110 to the effect that the user is asked to perform replacement due to consumption of the consumable component 106 in the apparatus (ST15).

The user PC 103 displays the message information 108 indicative of the need for replacement by the user due to the consumption of the consumable component 106 of the digital MFP 101, which has been received via the network 111 (ST16).

On the other hand, when the service-side PC 104 has received the message 110 via the network 111, it displays the message 110 indicative of the need for replacement by the user due to the consumption of the consumable component 106 in the digital MFP 102 (ST17).

As has been described above, according to the embodiment of the invention, two message information units, which correspond to a type of parts/consumable components replacement performed by the serviceman and a type of parts/consumable components replacement performed by the user, are pre-stored in the ROM. The message information is selected in accordance with the type of the apparatus. Therefore, there is no need to prepare message information for individual cases, and the number of development steps, as well as the cost, can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus with a communication function, comprising:
a first memory section that pre-stores first replacement message information relating to a part or a consumable component in the electronic apparatus at a time when replacement of the part or the consumable component occurs;
a second memory section that pre-stores second replacement message information relating to a part or a consumable component in the electronic apparatus at a time when replacement of the part or the consumable component occurs; and
a control section that effects a control to read out the first or second replacement message information stored in the first memory section or the second memory section in accordance with Replace Unit Type information of the electronic apparatus, when replacement of the part or consumable component in the electronic apparatus occurs, and to transmit the read-out replacement message information to a predetermined transmission destination using the communication function.

2. The electronic apparatus according to claim 1, wherein the first memory section that pre-stores the first replacement message information relating to the part or consumable component and the second memory section that pre-stores the second replacement message information relating to the part or consumable component are provided in a ROM.

3. The electronic apparatus according to claim 1, wherein the Replace Unit Type of the electronic apparatus is one of a Type in which the part or consumable component in the electronic apparatus is replaced by a serviceman, and a Type in which the part or consumable component in the electronic apparatus is replaced by a user.

4. An electronic apparatus with a communication function, comprising:
a first memory section that pre-stores replacement message information at a time when a part or a consumable component of the electronic apparatus is replaced by a serviceman;
a second memory section that pre-stores replacement message information at a time when a part or a consumable component of the electronic apparatus is replaced by a user; and
a control section that effects a control to determine, when replacement of the part or the consumable component in the electronic apparatus occurs, whether the electronic apparatus is a type for replacement by the serviceman or a type for replacement by the user, to read out the replacement message information stored in the first memory section or the second memory section in accordance with the determined type, and to transmit the read-out replacement message information to a predetermined transmission destination using the communication function.

5. The electronic apparatus according to claim 4, wherein the predetermined transmission destination is a personal computer possessed by the serviceman in a case of the type for replacement by the serviceman, or is a personal computer possessed by the user in a case of the type for replacement by the user.

6. An information transmission method for an electronic apparatus with a communication function, comprising:
pre-storing replacement message information at a time when a part or a consumable component in the electronic apparatus is replaced by a serviceman;
pre-storing replacement message information at a time when a part or a consumable component in the electronic apparatus is replaced by a user;
determining, when replacement of the part or the consumable component in the electronic apparatus occurs, whether the replacement of the part or the consumable component is a type for replacement by the serviceman or a type for replacement by the user;
reading out the replacement message information associated with the replacement by the serviceman in a case of the type in which the replacement of the part or the consumable component in the electronic apparatus is the type for replacement by the serviceman, and transmitting the read-out replacement message information to a serviceman-side personal computer; and
reading out the replacement message information associated with the replacement by the user in a case of the type in which the replacement of the part or the consumable component in the electronic apparatus is the type for replacement by the user, and transmitting the read-out replacement message information to a user-side personal computer.
